(19) United States
(12) Patent Application Publication
(10) Pub. No.: US 2006/0253249 A1
(43) Pub. Date: Nov. 9, 2006

(54) High occupancy vehicle restriction aware navigation system

(76) Inventor: Christian Bruelle-Drews, Hamburg (DE)

Correspondence Address: INDIANAPOLIS OFFICE 27879;BRINKS HOFER GILSON & LIONE, ONE INDIANA SQUARE, SUITE 1600, INDIANAPOLIS, IN, 46204-2033, US

(21) Appl. No.: 10/544,288

(22) PCT Filed: Feb. 11, 2003
(86) PCT No.: PCT/US03/04157

§ 371 Date: Apr. 27, 2006

(51) Int. Cl. G01C 21/32

(52) U.S. Cl. 701/209; 701/200; 340/995.19

(57) ABSTRACT

A vehicle navigation system (100) is provided for storing high occupancy vehicle restriction values for sections of road. The system may include seat occupancy sensors (130) that indicate whether seats in the vehicle are occupied. The system may also include a processor (110) that determines the number of occupants in the vehicle based on signals from the seat occupancy sensors (130) or input from a user. The processor (110) may determine whether the vehicle is authorized to traverse a section of road based on a high occupancy vehicle restriction value for the section of road and the number of occupants in the vehicle. The system may also include a display (140) and/or a speaker (150) so that the processor may communicate to a user whether the vehicle is authorized to travel on the section of the road.

### BACKGROUND OF THE INVENTION

1. Technical Field

This invention relates generally to a navigation system, and more particularly to the generation of standard heights with a satellite navigation system.

2. Background of the Invention

The height generally depicted on topographic maps and physical markers is the standard height H The standard height H indicates the height above mean sea level, and is determined by geodetic leveling. The standard height system may sometimes be referred to as the orthometric height system or the normal height system.

The National Geodetic Survey determines heights for the standard height system in the United States by taking physical measurements and using geodetic leveling. Government agencies in other countries perform similar functions, such as the State Survey Authority of the Federal State of Baden Württemberg (Landesvermessungsami Baden Württemberg) in Germany, and the Federal Office of Topography (Bundesamt für Landestopographie) in Switzerland.

Heights obtained from satellite navigation systems, such as the Global Positioning Systems (GPS) of the United States or the Global Orbiting Navigation Satellite System (Glonass) of the Russian Federation, utilize a different height system than those obtained with geodetic leveling. Satellite navigation system data is generally processed to obtain an ellipsoidal height h. An ellipsoidal height h is a height above or below a simple ellipsoid model of the Earth, such as the World Geodetic System 1984 (WGS84) ellipsoid model of the Earth.

It would be desirable to provide a vehicle navigation system that determines the number of vehicle occupants, and accordingly includes or excludes HOV restricted sections of road in route calculations. It would be further desirable to provide a vehicle navigation system that notifies a user that HOV restricted sections of road may be used or must be avoided during vehicle operation.

### SUMMARY

A vehicle navigation system is provided that includes provisions for storing and retrieving HOV restriction values for sections of road. The HOV restriction values may be stored as part of a digital map. The digital map may be stored by a processor.

The system may include seat occupancy sensors that indicate whether seats in the vehicle are occupied by occupants. Signals from the seat occupancy sensors may be used by the processor to determine the number of occupants in the vehicle. Alternatively, the driver or passenger manipulating the vehicle navigation system may input the number of occupants present in the car into the system The processor may also determine whether the vehicle is authorized to traverse a section of road based on an HOV restriction value for the section of road and the signals from the seat occupancy sensors.

The processor may calculate routes to a destination using the information on the number of occupants to determine whether the vehicle is authorized to travel on particular roads between a present location and the destination. The system may also include a display and/or a speaker so that the processor may communicate to a vehicle occupant whether the vehicle is authorized to travel on a section of road.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The invention can be better understood with reference to the following figures. The components in the figures are not necessarily to scale; emphasis is instead being placed upon illustrating the principles of the invention. Moreover, in the figures, like reference numerals designate corresponding parts throughout the different views.

FIG. 1 is a functional block diagram of a vehicle navigation system.

FIG. 2 is a flow chart for a route calculation algorithm for the vehicle navigation system of FIG. 1.

FIG. 3 is an illustrative map displayed by the vehicle navigation system of FIG. 1 identifying an HOV restricted section of road.

FIG. 4 is an illustrative magnified map displayed by the vehicle navigation system of FIG. 1 identifying an HOV restricted sections of road.

### DETAILED DESCRIPTION OF THE PREFERRED EMBODIMENTS

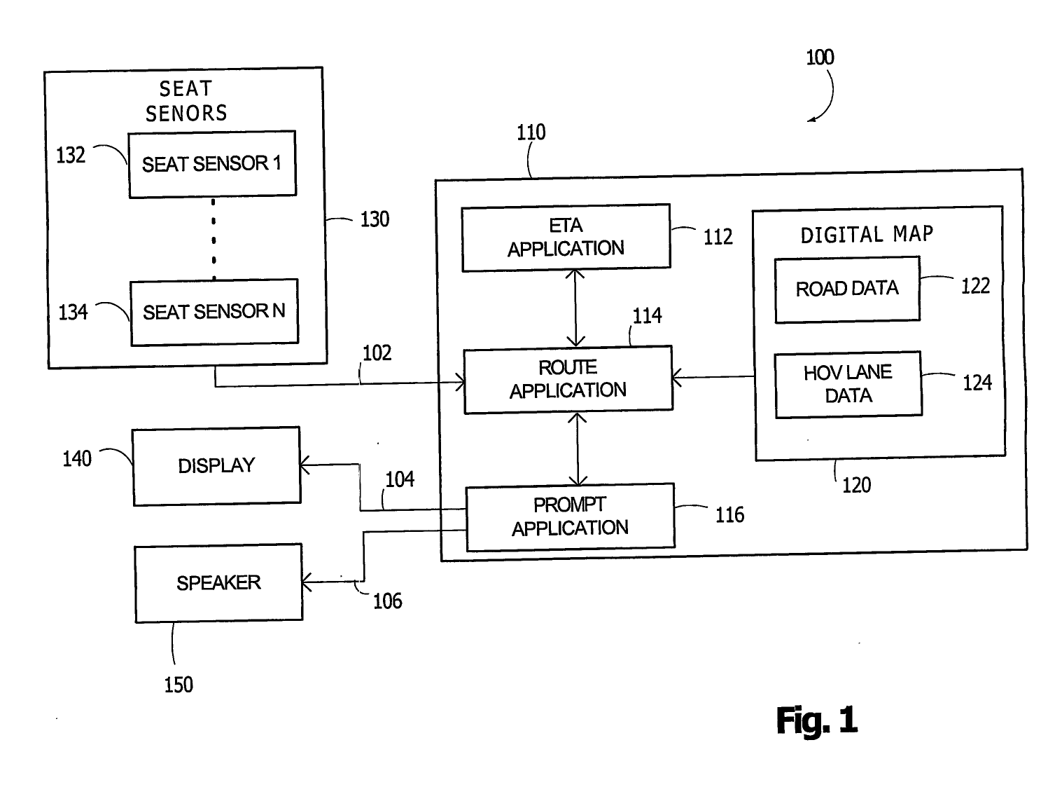

FIG. 1 is a functional block diagram of a vehicle navigation system 100 for use in a vehicle. The navigation system 100 may include a processor 110, seat sensors 130, a display 140, and a speaker 150. The processor 110 may include a central processing unit (CPU) such as an Intel Pentium microprocessor, a Sun SPARC microprocessor, a Motorola microprocessor, or a Hitachi SuperH RISC CPU core. Additionally, the processor 110 may include a storage device (not shown) such as a hard disk drive, a compact disc drive, a digital versatile disc drive, or the like. The navigation system 100 may calculate routes based on information located in storage and/or optionally based on receiving information from a global positioning satellite (GPS).

Each seat sensor 132 and 134 may include a seat occupancy sensor of the type generally found in automobiles, such as the Occupant Detection System manufactured by Flexpoint, Inc. Seat sensors 132 and 134 may each be coupled to a seat in the vehicle and generate a signal indicating whether the respective seat is occupied. It is not necessary for every seat in the vehicle to be associated with one of the seat sensors 130. For example, where the vehicle is a van, perhaps only three or four of the many seats may be associated with one of the seat sensors 130.

As used herein, the phrase “coupled to” is defined to mean directly connected to or indirectly connected through one or more intermediate components. Such intermediate components may include both hardware and software based components. For example, seat sensors 130 may be coupled directly to processor 110 via signal path 102. Alternatively, seat sensors 130 may be coupled to a vehicle communication bus, which may be coupled to processor 110 via signal path 102. As another alternative, signal path 102 may be a portion of a vehicle communication bus system Additionally, if the vehicle is not equipped with seat sensors, the driver or passenger may manually enter into the navigation system the number of occupants in the vehicle. Similarly, even in a vehicle with sensors, the navigation system may provide for the sensed number of occupants to be modified by the driver or passenger to account for inaccuracies, such as non-human load placed in a seat and possibly triggering the sensor.

The display 140 may be any display suitable for mounting in a vehicle, and preferably a flat panel display capable of displaying a digital road map. The speaker 150 may be a general purpose speaker capable of reproducing synthetic or recorded speech, or a specialized transducer capable of producing tones or other audible cues.

The processor 110 may include an estimated time of arrival (ETA) application 112, a route application 114, a prompt generation application 116, and a digital map 120. The digital map 120 may include road data 122 and HOV data 124. The HOV data may include HOV values for HOV restricted sections of road, indicating the minimum number of occupants a vehicle may lawfully carry over a road, times of day when a restriction is in effect, and the like. The digital map 120 may be modifiable by downloading data via a communications port or a wireless channel, or by installing data from a removable media such as a compact disc, digital versatile disc, memory card, or the like. Such modifications may include changes or updates to any of the map data including the HOV data.

The route application 114 may include instructions to the processor 110 to generate a route from a current vehicle location to a desired destination. For example, a user may enter a desired destination into processor 110. The route application 114 may cause the processor 110 to generate a set of possible routes and select a route from the set based on input from the user. For example, the user may indicate that the route application 114 is to include or exclude limited access highways, toll roads, toll bridges, or the like. After a route has been selected, the route application 114 may cause the processor 110 to continually update the “remaining” route as the vehicle progresses toward the destination based on, for example, updated information that may be received from the navigation system contact with GPS or from downloaded updated data.

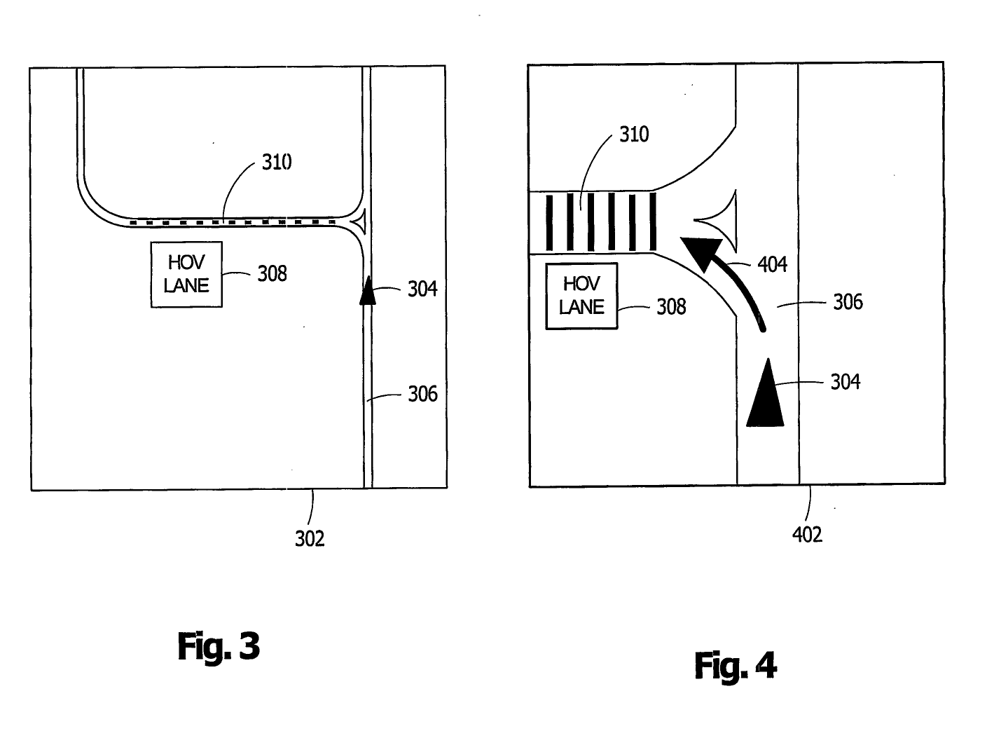

The prompt application 112 may include instructions for causing the processor 110 to notify the user of the route throughout a journey. For example, the prompt application 112 may cause the processor 110 to generate a map on the display 140 via the signal path 104. Illustrative maps are shown in FIGS. 3 and 4. The map may indicate the route in a different color than other displayed roads, indicate the route with arrows, or indicate it with text prompts or other visual cues. Indication of HOV restricted routes also may be provided by such visual cues.

The prompt application 112 may also cause the processor 110 to generate audible cues through the speaker 150. Audible cues may be tones indicating, for example, an upcoming turn on the route, or arrival at the destination. Alternatively, the audible cues may be a recorded or synthesized voice making statements, such as, “Approaching right turn.” Indication of HOV-type restricted routes also may be indicated by such visual cues.

The ETA application 112 may include instructions for causing the processor 110 to determine an amount of time required to travel a route or a portion of a route. For example, the ETA application 112 may cause the processor 110 to receive a distance, a speed limit, information regarding traffic congestion, and information regarding potential HOV-type routes from route application 114. Based on this information, the ETA application 112 causes the processor 110 to calculate a minimum travel time based on distance and maximum speed, or a compensated travel time allowing for traffic congestion or use of HOV-type routes.

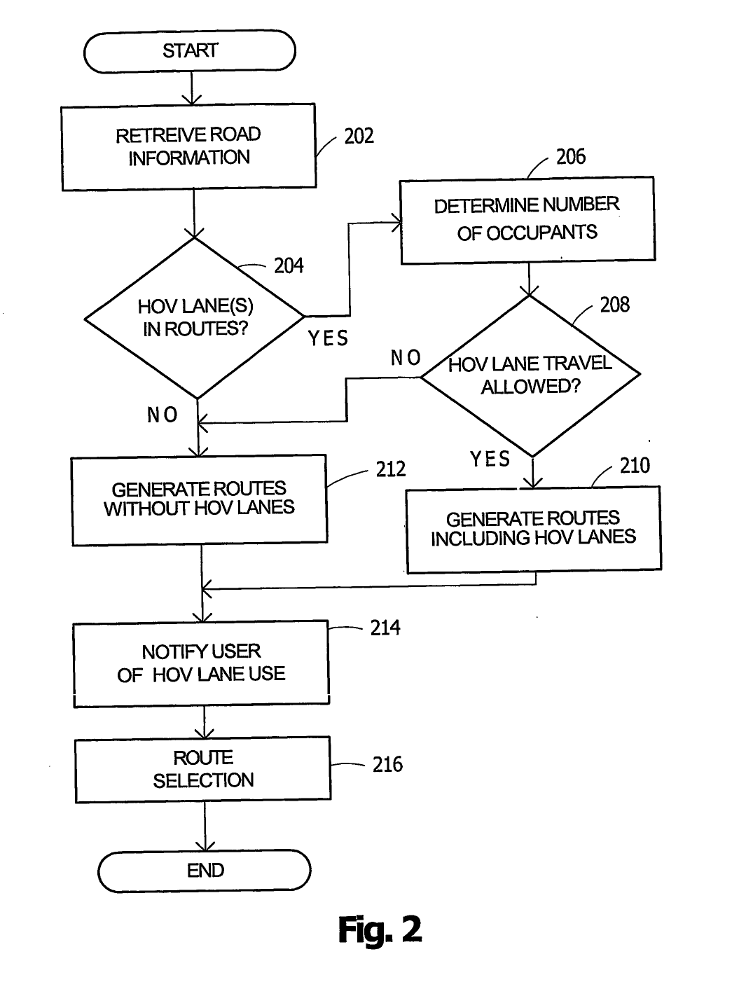

Turning to FIG. 2, a flow chart for operation of the route application 114 is shown. When a user enters a destination into the navigation system 100, at step 202 the route application 114 may cause the processor 110 to retrieve road data 122 and HOV data from digital map 120.

At step 204, the route application 114 may cause the processor 110 to determine whether there are HOV restricted sections of road in routes to the destination. If there are no HOV restricted sections of road in the routes, then the route application 114 may cause the processor 110 to progress to step 212 and generate routes without HOV restricted sections of road.

If, however, at step 204 the processor 110 determines that there are HOV restricted sections of road in routes to the destination, then the route application 114 may cause the processor 110 to progress to step 206. At step 206, the route application 114 instructs the processor 110 to determine the number of occupants in the vehicle. To determine the number of occupants, the processor 110 may read signals generated by the seat sensors 130 via signal path 102. Alternatively, the processor may retrieve the information on occupancy entered by the driver or passenger.

At step 208, the route application 114 instructs the processor 110 to determine whether travel via HOV restricted sections of road is allowed based on the number of vehicle occupants and the HOV value for HOV restricted sections of road in the routes to the destination. For example, if an HOV restricted section of road is restricted to vehicles with a minimum of two occupants, and the vehicle has only a driver, then the HOV restricted section of road would be excluded from the calculated routes.

Additionally, because sections of road may have HOV restrictions that vary with time at step 208 the route application 114 may cause the processor 110 to execute the ETA application 112 and estimate whether HOV restrictions will be in place when the vehicle is likely to reach a particular HOV restricted section of road in a route.

If the processor 110 determines at step 208 that travel via an HOV restricted section of road travel is not allowed, then the processor 110 progresses to step 212. At step 212, the route application 114 may instruct the processor 110 to generate routes not including HOV restricted sections of road. Under this scenario, routes including HOV restricted sections of road are actively excluded during route generation. After allowable routes are generated, the processor 110 progresses to step 214.

If, however, the processor 110 determines at step 208 that travel via HOV restricted sections of road is allowed, then the processor 110 progresses to step 210. At step 210, the route application 114 may cause the processor 110 to generate routes that include HOV restricted sections of road. At step 214, the route application 114 may instruct the processor 110 to notify the user whether travel via HOV restricted sections of road is allowed. For example, the processor 110 may generate text prompts or graphics, and communicate the text prompts or graphics to the display 140 via the signal path 104. Alternatively, the processor 110 may generate tones or spoken messages, and communicate the tones or spoken messages to the speaker 150 via the signal line 106.

At step 216, the route application 114 may instruct the processor 110 to execute the prompt application 116. In one embodiment, the prompt application 116 may cause the processor 110 to prompt the user to select one route from the set of generated routes. The prompt may include, for example, distances, estimated times, and restricted lanes or roads associated with each route. If there is only one generated route, then the processor 110 may perform no action at step 216 or step 216 may be omitted.

The route application 114 and the prompt application 116 may cause the processor 110 to generate and display maps on the display 140. FIG. 3 shows an illustrative map 302. A cursor 304 representing a current location of the vehicle is shown traveling a section of road 306 that has HOV restrictions. The vehicle is approaching an intersection with a section of road 310 that has HOV restrictions. Symbols may be used to indicate that the section of road 310 is HOV restricted. The symbols shown in FIG. 3 are merely illustrative, and any type of markings may be used. Additionally, a text prompt 308 may indicate that the section of road 310 is HOV restricted. Alternatively, the section of road 310 may be shown in a different color than the section of road 306 in order to indicate that the section of road 310 is HOV restricted.

The route application 114 and the prompt application 116 may cause the processor 110 to generate and display magnified maps on the display 140 when a turn is recommended. FIG. 4 shows an illustrative magnified map 402. The cursor 304 is shown traveling a road 306 and approaching an intersection with the HOV restricted section of road 310. In this illustrative example, the vehicle includes a sufficient number of vehicle occupants to allow travel over the HOV restricted section of road 310. To indicate that the vehicle is allowed to travel over the section of road 310, arrow 404 indicates a recommended travel path to the user. Additionally, the prompt application 116 may cause the processor 110 to generate a tone or spoken prompt, such as “Approaching left turn.”

In another illustrative example, the vehicle does not include a sufficient number of vehicle occupants to allow travel over HOV restricted section of road 310. If the vehicle inadvertently enters the HOV restricted section of road 310, the prompt application 116 may cause the processor 110 to generate a tone or spoken prompt, such as “Unauthorized HOV lane usage.” The prompt application 116 may additionally cause the processor 110 to generate visual indications of unauthorized vehicle operation, and display these indications via display 140.

While various embodiments of the invention have been described, it will be apparent to those of ordinary skill in the art that many more embodiments and implementations are possible that are within the scope of this invention. Accordingly, the invention is not to be restricted except in light of the attached claims and their equivalents.

1. A vehicle navigation system comprising:
a processor operable to store an HOV restriction value for a section of road and operable to receive information regarding a number of occupants in the vehicle;
where the processor is configured to compare the number of occupants in the vehicle to the HOV restriction value of the section of road; and
where the processor determines a route as a function of the comparison of the number of occupants in the vehicle to the HOV restriction value of the section of road.

2. The vehicle navigation system of claim 1 further comprising a seat occupancy sensor operable to generate a signal indicating whether a seat is occupied.

3. The vehicle navigation system of claim 2 where the seat occupancy sensor provides the signal to the processor.

4. The vehicle navigation system of claim 1 where a user provides information to the processor regarding the number of occupants in the vehicle.

5. The vehicle navigation system of claim 1 where the HOV restriction value for a section of road is provided via wireless connection.

6. (canceled)

7. The vehicle navigation system of claim 1 further including a display coupled to the processor, where the processor generates a map indicating the existence of an HOV restriction value for a section of road and displays the map on the display.

8. The vehicle navigation system of claim 1 further including a speaker coupled to the processor, where the processor generates a sound indicating the existence of an HOV restriction value for a section of road and plays the sound via the speaker.

9. The vehicle navigation system of claim 1 further including a speaker coupled to the processor, where the processor generates a sound played via the speaker indicating a route recommendation based on the comparison.

10. A navigation system for a vehicle comprising:
a seat occupancy sensor coupled to a seat in the vehicle and operable to generate an occupancy signal indicating whether the seat is occupied;
a processor coupled to the seat occupancy sensor and operable to store a high occupancy vehicle restriction value for a section of road; and
a display coupled to the processor, where the processor generates a map indicating the high occupancy vehicle restriction value for the section of road and displays the map on the display;
where the processor is configured to receive the occupancy signal, determine a number of occupants in the vehicle based on the occupancy signals, and compare the number of occupants in the vehicle to the high occupancy vehicle restriction value for the section of road.

11. The navigation system of claim 10, where the processor determines a route to a destination as a function of the number of occupants in the vehicle and the high occupancy vehicle restriction value for the road.

12. (canceled)

13. The navigation system of claim 10 further including a speaker coupled to the processor, where the processor generates a sound indicating the high occupancy vehicle restriction value for the section of road, and plays the sound via the speaker.

14. The navigation system of claim 10 further including a speaker coupled to the processor, where the processor generates a sound played via the speaker indicating a route recommendation based on the comparison of the number of occupants to the high occupancy vehicle restriction value.

15. A method for navigating a vehicle, the method comprising:
retrieving a high occupancy vehicle restriction value for a section of road;
receiving an occupancy signal from a seat occupancy sensor indicating whether a seat in the vehicle is occupied;
determining a number of occupants in the vehicle based on the occupancy signal; and
determining whether the vehicle is authorized to traverse the section of road based on a comparison of the high occupancy vehicle restriction value to the number of occupants.

16. The method of claim 15 further comprising the step of storing the high occupancy vehicle restriction value.

17. The method of claim 15 further comprising storing a digital map that includes the high occupancy vehicle restriction value.

18. The method of claim 15 where determining whether the vehicle is authorized includes determining whether the number of occupants is at least equal to the high occupancy vehicle restriction value.

19. The method of claim 15 further comprising determining a route to a destination based on the comparison.

20. The method of claim 15 further comprising determining a route that includes the section of road where the vehicle is authorized to traverse the section of road.

21. The method of claim 15 further comprising determining a route that excludes the section of road where the vehicle is not authorized to traverse the section of road.

22. The method of claim 15 further comprising generating a map indicating the existence of the high occupancy vehicle restriction value for the section of road, and displaying the map on a display.

23. The method of claim 15 further comprising generating a sound indicating the existence of the high occupancy vehicle restriction value for the section of road, and playing the sound via a speaker.

24. The method of claim 15 further comprising generating a sound indicating the vehicle is not authorized to traverse the section of road based on the comparison, and playing the sound via a speaker.

25. A navigation system for a vehicle comprising:
a seat occupancy sensor;
a processor coupled to the seat occupancy sensor;
a display coupled to the processor;
where the processor includes a program of instructions comprising:
instructions to retrieve a high occupancy vehicle restriction value for a section of road;
instructions to receive an occupancy signal from the seat occupancy sensor;
instructions to determine a number of occupants in the vehicle based on the occupancy signal;
instructions to compare the high occupancy vehicle restriction value to the number of occupants;
instructions to determine whether the vehicle is authorized to traverse the section of road based on the comparison; and
instructions to generate a map indicating the high occupancy vehicle restriction value for the section of road and to display the map on the display.

26. The navigation system of claim 25 where the processor includes a digital map that includes the existence of the high occupancy vehicle restriction value for the section of road.

27. The navigation system of claim 25 where the program of instructions further comprises instructions to determine a route based on whether the vehicle is authorized to traverse the section of road.

28. (canceled)

29. The navigation system of claim 25 further including a speaker coupled to the processor, where the program of instructions further comprises instructions to generate a sound indicating the existence of the high occupancy vehicle restriction value for the section of road, and to play the sound via a speaker

30. The navigation system of claim 25, further including a speaker coupled to the processor, where the program of instructions further comprises instructions to generate a sound indicating the vehicle is not authorized to traverse the section of road, and to play the sound via a speaker.

31. A vehicle navigation system comprising:
a means for storing an HOV restriction value for a section of road;
a means for receiving information regarding a number of occupants in the vehicle; and
a means for comparing the number of occupants in the vehicle to the HOV restriction value of the section of road.

32. The vehicle navigation system of claim 31 further comprising a means for generating a signal indicating whether a seat is occupied.

33. The vehicle navigation system of claim 31 further comprising a means for providing information indicating whether the seat is occupied to the processor.

34. The vehicle navigation system of claim 31 where the means for comparing further determines a route as a function of the comparison of the number of occupants in the vehicle to the HOV restriction value of the section of road.

35. The vehicle navigation system of claim 34 further including a means for providing information to an occupant of the vehicle regarding the route.
